(19) United States
(12) Patent Application Publication
(10) Pub. No.: US 2007/0094603 A1
(43) Pub. Date: Apr. 26, 2007

(54) System and method for providing for the secure management of mobile user interface customizations and personalizations

(75) Inventor: Jussi Yli-Urpo, Tampere (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/254,646

(22) Filed: Oct. 20, 2005

(51) Int. Cl. G06F 17/00

(52) U.S. Cl. 715/741; 715/747

(57) ABSTRACT

A system and method for preventing further customization and/or personalization of user interface elements and/or their properties. According to the present invention, locking attributes are defined in user interface definition files that are used to describe the application user interface. Element lockings may be used to prevent all modifications to the element at issue. Style lockings may be used to prevent layout and appearance modifications.

### FIELD OF THE INVENTION

The present invention relates generally to user interfaces on devices such as mobile electronic devices. More particularly, the present invention relates to the control of future securitization and customization of user interface elements and properties on mobile electronic devices.

### BACKGROUND OF THE INVENTION

User interface applications in mobile electronic devices such as mobile telephones and personal digital assistants (PDAs) need to be flexible in order to support the needs of several stakeholders. In particular, a single electronic device may be modified and/or customized by a platform provider, a device vendor, an operator, an enterprise and an end-user. Each of these stakeholders usually has different requirements for the structure, interaction, appearance and layout of the user interface.

Although all of the stakeholders listed above may need to customize the user interface on a particular electronic device, customization and personalization of mobile user interfaces cannot be allowed without the existence of a certain degree of control. Currently, there is a need to include a mechanism that selectively permits certain stakeholders to customize the user interfaces to a greater extent than other stakeholders. Because of varying customization and personalization policies and business cases, the exact limitations must be capable of being defined differently for each device model, device vendor and operator/enterprise. These limitations need to be defined in a secure and precise manner and on the level of the user interface component. There is also a need to be able to modify such locking information of an existing application over-the-air.

U.S. Patent Application Publication No. 2005/0050474A1 describes one system for the customization of the user interface on an electronic device. This publication discusses a system in which XML files may be used to define visual attributes of the user interface for user interface customization. However, this system is limited to the use of XML, and the control/locking attributes of the system only affect the application menu structure or hierarchy. In this sense, the system described in this publication is quite limited in its capabilities. Additionally, in this system, XML files must be compiled to another format before a theme can be downloaded to a device.

In addition to the above, Linux KDE's Kiosk mode allows an entity to lock values read from configuration files so that the values cannot be overridden by subsequently read values. However, this system is also limited in several respects. In particular, the Kiosk mode permits parties to only lock certain appearance and behavior-related appearances and is not capable of permitting many parts of a user interface from being locked to downstream parties.

### SUMMARY OF THE INVENTION

The present invention provides for a system and method of preventing further-customization and/or personalization of user interface elements and/or their properties. This is accomplished by defining locking attributes in a user interface definition file, such as an XML-based user definition file, that is used to describe the application user interface.

The present invention enables the implementation of a generic user interface customization and personalization system that can be precisely configured to support different devices, device vendors, operators, enterprises and end-user requirements on application user interface element and style property levels. The present invention allows for over-the-air (OTA) updating of locking information of a user interface, allowing stakeholders to revise their customization and personalization policies whenever needed and even on a device-by-device basis.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is an overview diagram of a system within which the present invention may be implemented;

FIG. 2 is a perspective view of an electronic device that can incorporate the principles of the present invention; and

FIG. 3 is a schematic representation of the circuitry of the electronic device of FIG. 2.

### DETAILED DESCRIPTION OF THE PREFERRED EMBODIMENTS

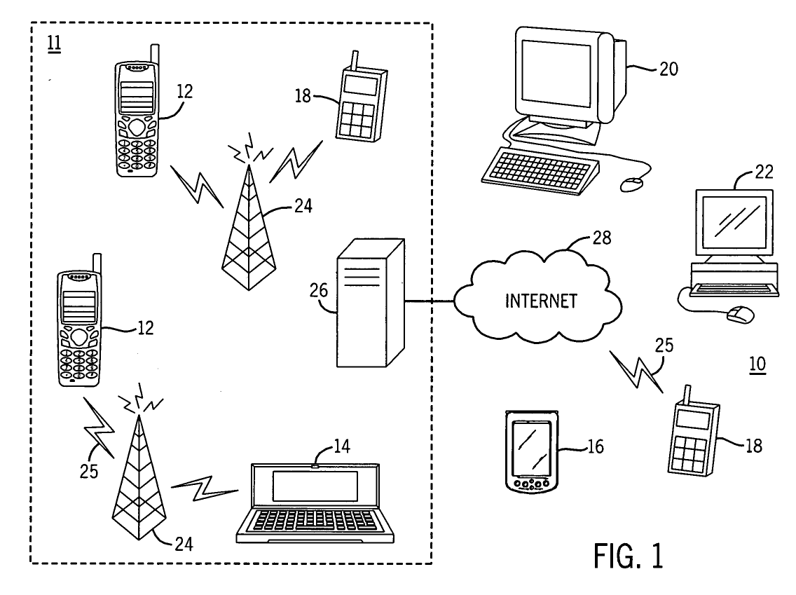

FIG. 1 shows a system 10 in which the present invention can be utilized, comprising multiple communication devices that can communicate through a network. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 1 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, a mobile telephone 12, a combination PDA and mobile telephone 14, a PDA 16, an integrated messaging device (IMD) 18, a desktop computer 20, and a notebook computer 22. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

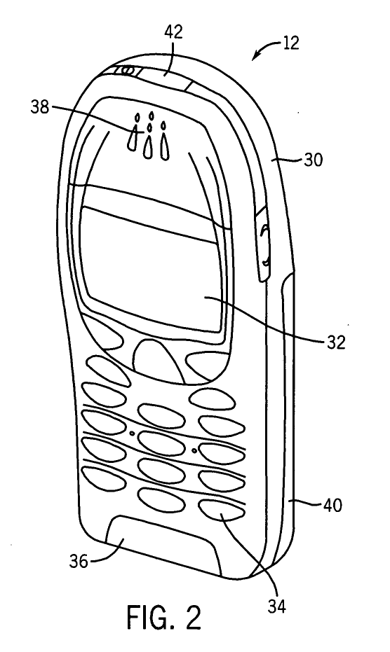

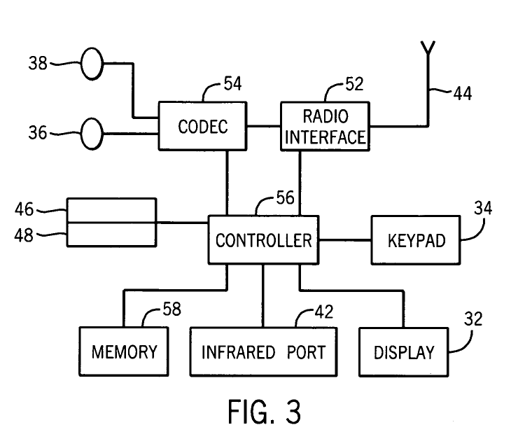

FIGS. 2 and 3 show one representative mobile telephone 12 within which the present invention may be implemented. It should be understood, however, that the present invention is not intended to be limited to one particular type of mobile telephone 12 or other electronic device. The mobile telephone 12 of FIGS. 2 and 3 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The present invention provides a system and method for preventing further-customization and/or personalization of user interface elements and/or their properties in an electronic device. The present invention defines locking attributes in a user interface definition file that is used to describe the application user interface. The advantage of using an XML file is that the information is easy to manage, and no separate files or systems are needed.

In one embodiment of the invention, the locking information can be defined separately for each user interface component. In yet another embodiment, modifications to the appearance and layout can be locked separately from other features and functions. It is also possible to lock individual style properties, such as a background image or position of a component.

With the present invention, an operator can easily limit the personalization of certain items on an application user interface and to prevent the medication of certain elements and aspects.

The present invention can be implemented as be part of an XML user interface framework subsystem. It should be noted, however, that the present invention is not limited XML-based systems and can also be implemented in a variety of non XML-based environments. In one embodiment of the invention, the locking definitions are declared in XML-based user interface definition files as attributes. In most conventional systems, locking information is stored in user interface definitions contained in the respective device's read only memory.

In a XML-based user interface description (markup) language and a XML-based user interface framework, there are two types of lockings according to one embodiment of the present invention—element lockings and style lockings. Element lockings prevent all modifications to the element at issue. Element lockings prevent modifying XML attributes of the element, modifying style (CSS) properties of the element, removing the element itself and adding new child-elements to the element. The lockings are hierarchical in nature, meaning that the locking of the root element in XML locks the whole user interface (UI) from all modifications. Lockings are also cumulative in nature so that a child element can add new lockings. In addition, a child element can also “undo” all of the lockings defined by a parent or parents.

According to one embodiment of the present invention, element lockings are defined by defining a value “true” for the XML attribute “locked” for any XML UI ML or FW element. By default, all elements are unlocked in one embodiment of the invention. The following XML code shows examples where (1) an entire view is locked on a user interface; (2) a button on the user interface is locked and (3) an image associated with the button is unlocked in one embodiment of the present invention. Comment code is also included.

<xmluiml>

<views>

<view id=”lockedview” locked=”true”><!-- whole view locked -->

...

</view>
<view id=”unlockedview”><!-view is not locked --> ...
</view>
<view id=“partiallylockedview”>

<mainpane>

<button locked=“true”><!--only this button and its

children are locked in this view -->

<image/><!the image is also locked because

of the parent-->

<image locked=“false”/><!-overrides

locking: the image is therefore not locked -->

</button>
<button/><!-- not locked -->

</mainpane>

...

</views>

</xmluiml>

In contrast to element lockings, style lockings only prevent layout and appearance modifications. It is possible to either lock all properties of the element or just the listed properties with style lockings. By default, all style properties of an element are unlocked unless the whole element is locked in one embodiment of the invention. Style lockings are hierarchical and cumulative in nature unless reset by a child element. The following computer code shows the implementation of various style lockings, along with associated comment coding.

<xmluiml>

<views>

<view id=”lockedview”>

<mainpane>

<button stylelocked=“true”><!--all style properties

locked -->

<image/><!--also style locked -->
<image stylelocked=“false”/><--image is not

stylelocked ->

</button>
<button locked=“true” stylelocked=“false”><!--

everything but style locked -->

<image/><!--also everything but style locked-->
<image stylelocked=“background_color color”/>

<!-- in addition color and background_color property are locked -->

</button>
<box stylelocked=“left right top bottom”><!-- only

positioning properties are locked -->

<image stylelocked=“false”/><!-- locking reset:

nothing locked -->

<image stylelocked=“color”/><!-- in addition to

positioning properties also color property is locked -->

</box>

</mainpane>

...

</views>

</xmluiml>

In the above code, it is shown how all style properties may be locked and unlocked, a color and background color can be locked, how positioning properties can be locked, and various other actions. It is also possible for other properties to be locked, such as the size or color of individual objects associated with the particular item.

A trusted party can also update locking information by delivering a new UI definition in one embodiment of the present invention. With this feature, it is possible to lock new items and allow customization of some earlier locked items as deemed necessary or desirable. In a related embodiment of the invention, subsequent OTA updates to the locking information can also be supported.

The present invention is described in the general context of method steps, which may be implemented in one embodiment by a program product including computer-executable instructions, such as program code, executed by computers in networked environments.

Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule-based logic and other logic to accomplish the various database searching steps, correlation steps, comparison steps and decision steps. It should also be noted that the words “component” and “module” as used herein, and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of selectively locking user interface attributes in a framework for an electronic device, comprising:
having a locking instruction inserted into a user interface definition file, the definition file describing an application user interface in the electronic device, the locking instruction relating to at least one user interface item; and
in response to the locking instruction, preventing modification of the at least one user interface item in accordance with the locking instruction.

2. The method of claim 1, wherein the at least one locking instruction comprises an element locking instruction for locking an element associated with the at least one user interface item.

3. The method of claim 2, wherein the element locking instruction prevents modifications to all attributes associated with the at least one user interface item absent the presence of contrary instructions for any associated attributes.

4. The method of claim 2, wherein the element locking instruction selectively prevents modifications to at least one specific attribute associated with the at least one user interface item.

5. The method of claim 2, wherein the element locking instruction prevents at least one action selected from the group consisting of modifying an attribute of the element, modifying at least one style property of the element, removing the element, and adding one or more new child-elements to the element.

6. The method of claim 1, wherein the at least one locking instruction comprises a style locking instruction for locking a style associated with the at least one user interface item.

7. The method of claim 6, wherein the style locking instruction prevents any appearance and layout modifications to the at least one user interface item absent the presence of contrary instructions for associated appearance and layout attributes.

8. The method of claim 6, wherein the style locking instruction prevents modifications to at least one selected appearance or layout attribute associated with the at least one user interface item.

9. The method of claim 6, wherein the style locking instruction prevents at least one action selected from the group consisting of modifying the background color associated with the at least one interface item, adjusting the positioning of an object associated with the at least one interface item, adjusting the color of an object associated with the at least one interface item, and adjusting the size of an object associated with the at least one interface item.

10. The method of claim 1, wherein the locking instruction is provided over the air from a remote location for insertion.

11. The method of claim 1, wherein the user interface definition file comprises an XML-based user interface definition file.

12. A computer program product for selectively locking user interface attributes in a framework for an electronic device, comprising:
computer code for having a locking instruction inserted into a user interface definition file, the definition file describing an application user interface in the electronic device, the locking instruction relating to at least one user interface item; and
computer code for, in response to the locking instruction, preventing modification of the at least one user interface item in accordance with the locking instruction.

13. The computer program product of claim 12, wherein the at least one locking instruction comprises an element locking instruction for locking an element associated with the at least one user interface item.

14. The computer program product of claim 13, wherein the element locking instruction prevents modifications to all attributes associated with the at least one user interface item absent the presence of contrary instructions for any associated attributes.

15. The computer program product of claim 13, wherein the element locking instruction selectively prevents modifications to at least one specific attribute associated with the at least one user interface item.

16. The computer program product of claim 12, wherein the at least one locking instruction comprises a style locking instruction for locking a style associated with the at least one user interface item.

17. The computer program product of claim 16, wherein the style locking instruction prevents any appearance and layout modifications to the at least one user interface item absent the presence of contrary instructions for associated appearance and layout attributes.

18. The computer program product of claim 16, wherein the style locking instruction prevents modifications to at least one selected appearance or layout attribute associated with the at least one user interface item.

19. The computer program product of claim 12, wherein the user interface definition file comprises an XML-based user interface definition file.

20. An electronic device, comprising
a processor; and
a memory unit operatively connected to the processor and including a computer program product for selectively locking user interface attributes in a framework for an electronic device, comprising:
computer code for having a locking instruction inserted into a user interface definition file, the definition file describing an application user interface in the electronic device, the locking instruction relating to at least one user interface item, and
computer code for, in response to the locking instruction, preventing modification of the at least one user interface item in accordance with the locking instruction.

21. The electronic device of claim 20, wherein the at least one locking instruction comprises an element locking instruction for locking an element associated with the at least one user interface item.

22. The electronic device of claim 21, wherein the element locking instruction prevents modifications to all attributes associated with the at least one user interface item absent the presence of contrary instructions for any associated attributes.

23. The electronic device of claim 21, wherein the element locking instruction selectively prevents modifications to at least one specific attribute associated with the at least one user interface item.

24. The electronic device of claim 20, wherein the at least one locking instruction comprises a style locking instruction for locking a style associated with the at least one user interface item.

25. The electronic device of claim 24, wherein the style locking instruction prevents any appearance and layout modifications to the at least one user interface item absent the presence of contrary instructions for associated appearance and layout attributes.

26. The electronic device of claim 24, wherein the style locking instruction prevents modifications to at least one selected appearance or layout attribute associated with the at least one user interface item.

27. The electronic device of claim 20, wherein the user interface definition file comprises an XML-based user interface definition file.
